(19) United States
(12) Patent Application Publication
(10) Pub. No.: US 2005/0116112 A1
(43) Pub. Date: Jun. 2, 2005

(54) High energy electric feed drive system

(76) Inventor: Donal S. Dunbar JR., Wichita Falls, TX (US)

Correspondence Address: Michael L. Diaz;Michael L. Diaz, P.C., Suite 200, 555 Republic Drive, Plano, TX, 75074, US

(21) Appl. No.: 10/717,848

(22) Filed: Nov. 19, 2003

(51) Int. Cl. F02K 1/00

(52) U.S. Cl. 244/172

(57) ABSTRACT

A high energy electric feed drive system. The drive system includes a vehicle, such as a spacecraft and a magnet mounted within the vehicle. An ignition system is powered by a power source. The ignition system provides a directed plasma stream at the magnet. When the plasma stream strikes the magnet, dispersion loops emanate from the magnet. A plurality of particle acceleration tubes are utilized to capture and direct the dispersion loops outwardly and in front of the magnet. When the dispersion loops exit the particle acceleration tubes, the dispersion loops attempt to find the magnet. In the process, the dispersion loops provide an attractive pulling source, thereby propelling the magnet and vehicle forward.

### BACKGROUND OF THE INVENTION

1. Technical Field of the Invention

This invention relates to high energy drive systems, and more particularly, to a drive system utilizing dispersion loops emitted from a magnet.

2. Description of Related Art

It is known that electromagnetic energy may propel an object. However, prior art references do not disclose utilizing the attractive forces between a natural magnet and dispersion loops created by directing an energy beam at the magnet to propel a vehicle. A system and method is needed to harness the attractive forces generated from the dispersion loops created by contacting an energy beam or plasma stream with a magnet.

Although there are no known prior art teachings of a system or method such as that disclosed herein, prior art references that discuss subject matter that bears some relation to matters discussed herein are U.S. Pat. No. 5,197,279 to Taylor (Taylor), U.S. Pat. No. 6,057,750 to Sheng (Sheng), U.S. Pat. No. 6,118,193 to Morris, U.S. Pat. No. 6,523,338 to Kornfeld et al. (Kornfeld), and U.S. Pat. No. 6,530,212 to Phipps et al. (Phipps).

Taylor discloses an electromagnetic energy propulsion engine system having a housing with a front and rear part of material transparent to the passage of electromagnetic fields, and electromagnetic field generating solenoidal windings which have central axes parallel with the central axis of the engine. The solenoidal windings provide a forward field generating winding and a rear field generating winding. The system also includes a control computer and a power pulse generator connected between the electromagnetic field generating windings and the electromagnetic field generating windings and the power source and control computer. The forward field generating winding generates a rearwardly directed magnetic field toward the rear wall parallel to the central axis and the rear field generating winding produces a forwardly directed magnetic field opposing the rearwardly directed magnetic field of the forward field generating winding so that the rearwardly directed magnetic field repels forwardly directed pulses of the rear magnetic generating winding. As the electrical current conduction in the rear field generating winding suddenly reduces, the continuing rearwardly directed magnetic field force transmits pulsating magnetic field energy produced by the rear field generating winding through the rear of the housing. The reaction to the rearwardly transmitted field energy produces a thrust propelling the engine and a vehicle in which it is mounted. However, Taylor does not teach or suggest an electromagnetic propulsion system which imparts a directed energy beam on a magnet to produce dispersion loops in a directed manner to cause an attractive pulling force ahead of a vehicle.

Sheng discloses a magnet device with double fixing positions for changing the magnetic circuit and includes an external housing whose inner edge is fitted with a coil. The inside of the external housing includes a space for the axial movement of an iron core. A drive circuit is provided whereby a positive impulse voltage is outputted and the electrical energy is saved in a capacitor when the power is switched on. A discharge current is created to output a negative impulse voltage after the power is switched off, and the positive and the negative impulse voltages service to make the coil change the direction of the magnetic force by the excitation process, so that a push force or a pull force on the iron core will be created for movement. However, Sheng does not teach or suggest a propulsion system which imparts a directed energy beam on a magnet and directs the dispersal loop byproducts in such a manner as to cause an attractive force for use in propelling a vehicle.

Morris discloses an electromagnetic device which includes an inertia ring disposed within an outer casing. The inertia ring may be rotated freely relative to the outer casing. The outer casing supports a pair of primary coils. The inertial ring carries a plurality of secondary magnetic coils. There is a pair of brushes that energizes the secondary magnetic coils on either side of the primary coils, as the secondary coils move past the pairs of brushes. The primary coils are energized to attract the secondary coils on one side while repelling the secondary coils on the other side to impart rotational movement to the inertia ring relative to the outer casing. However, Morris does not teach or suggest a propulsion system utilizing the attractive forces generated by a magnet and energy dispersed from the magnet when subjected to a directed energy beam.

Kornfeld discloses a propulsion system which utilizes an accelerated electron beam into an ionization chamber with fuel gas. The beam is guided through the ionization chamber in the form of a focused beam against an electric deceleration field. The electric deceleration field acts at the same time as an acceleration field of the fuel ions produced by ionization. The system generates a focused beam of a largely neutral plasma with a high degree of efficiency. However, Kornfeld does not teach or suggest a propulsion system utilizing dispersal loops emanating from a magnet to propel a vehicle.

Phipps discloses a propulsion system which utilizes a laser directed at an ablation target. When the laser is operating, material ablates from the ablation target, which generates a thrust vector on a spacecraft. However, Phipps merely discloses the use of directing a laser at an ablation target and does not teach or suggest harnessing the attractive forces of dispersal loops generated by imparting a directed energy beam at a magnet.

A review of the foregoing references reveals no disclosure or suggestion of a propulsion system which utilizes dispersion loops to create a pulling attract force to propel a vehicle. It is an object of the present invention to provide such a system and method.

### SUMMARY OF THE INVENTION

In one aspect, the present invention is a drive system for propelling a vehicle, such as a spacecraft. A magnet is mounted within the vehicle. An ignition system is powered by a power source and provides a directed energy beam, such as a plasma stream, at the magnet. Upon striking the magnet with the directed energy beam, dispersion loops emanate from the magnet. The system also includes at least one particle acceleration tube for capturing and guiding one of the dispersion loops. The guided dispersion loop exits the particle acceleration tube and attempts to seek the magnet. During this process, an attractive pulling force is created from the dispersion loop to the magnet, which causes the vehicle to move forward.

In another aspect, the present invention is a method of propelling a vehicle. The method begins by applying power to an ignition system. The ignition system creates a directed energy beam which is directed at a magnet. Upon striking the magnet with the energy beam, a plurality of dispersion loops emanate from the magnet. Next, a particle acceleration tube guides one of the dispersion loops outwardly and in front of the magnet. The dispersion loop then exits the particle acceleration tube. The dispersion loop attempts to seek the magnet, which creates a pulling force from the dispersion loop to the magnet, thereby causing the magnet and the vehicle to move.

In still another aspect, the present invention is a drive system for propelling a vehicle. The drive system includes a vehicle, a natural magnet mounted to the vehicle, and an ignition system powered by a power source. The ignition system provides a plasma stream for striking the magnet. Upon impact of the plasma stream on the magnet, a plurality of dispersion loops emanate from the magnet. A particle acceleration tube captures and guides one of the dispersion loops outwardly and in front of the magnet. When the guided dispersion loop exits the particle acceleration tube, the dispersion loop attempts to seek the magnet, thereby creating an attractive pulling force propelling the magnet and vehicle forward. The dispersion loops reverse polarity at predictable time intervals. A second particle acceleration tube may be utilized for capturing and guiding a second dispersion loop emanating from the magnet, which may be used to propel the vehicle forward during a polarity reversal.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of a magnetic drive system;

FIG. 2 is a top plan view of the drive system in the preferred embodiment of the present invention;

FIG. 3 is a side view of the drive system of FIG. 2; and

FIG. 4 is a flow chart outlining the steps for driving a vehicle according to the teachings of the present invention.

### DETAILED DESCRIPTION OF EMBODIMENTS

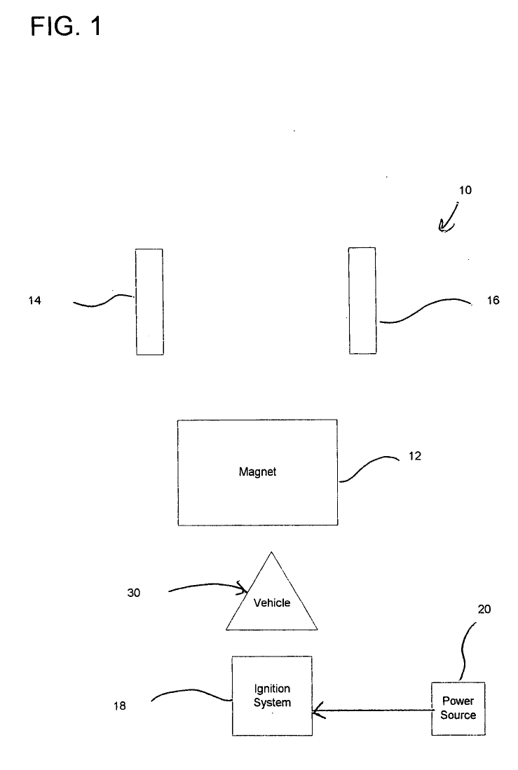

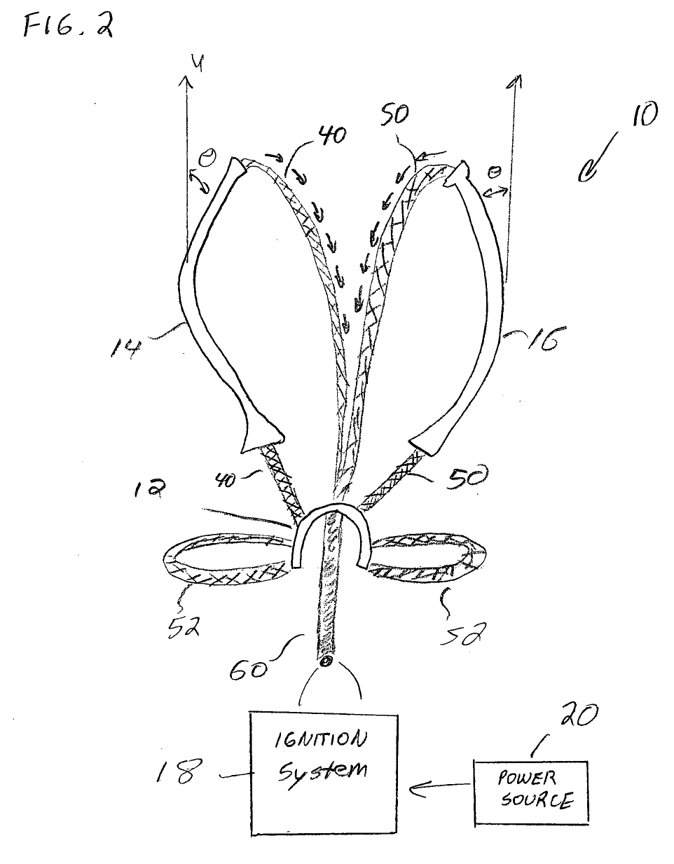

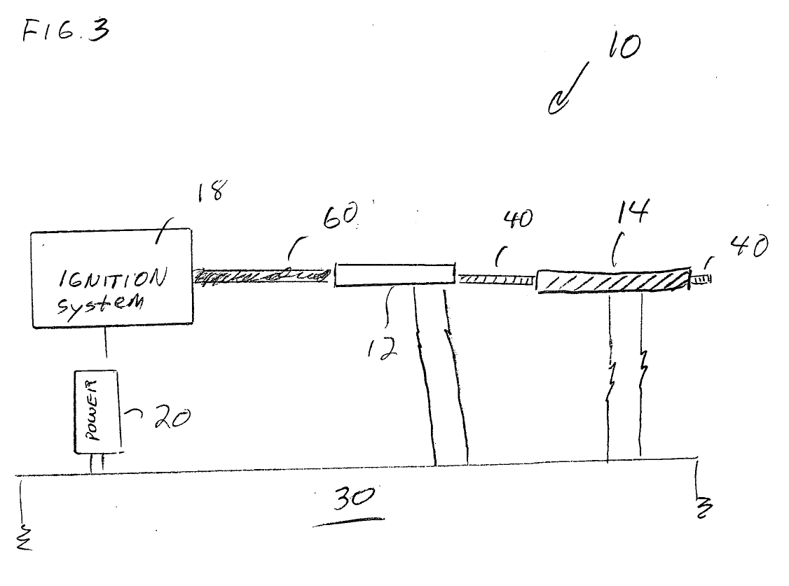

An energy induced magnetic phase propulsion system is disclosed. FIG. 1 is a simplified block diagram of a magnetic drive system 10. FIG. 2 is a top plan view of the drive system in the preferred embodiment of the present invention. FIG. 3 is a side view of the drive system of FIG. 2. The system includes a magnet 12, a plurality of particle acceleration tubes 14 and 16, an ignition system 18, and a power source 20. The entire system 10 is housed in a vehicle 30, such as a spacecraft.

The magnet is a natural magnet or “real earth” magnet. The ignition system is powered by the power source. The ignition system creates a controlled energy beam directed at the magnet. The controlled energy beam is preferably a plasma stream. The ignition system directs the energy beam in such a fashion as to directly strike the magnet. Such ignition systems which create plasma streams are in existence today, such as a conventional arc welder.

By directing the energy beam (plasma stream) into the magnet, the plasma stream is distributed and directed in dispersion loops 40 and 50 outlining magnetic lines of force extending from the magnet itself. The dispersion loops are symmetrical and form predictable patterns based on the amount of energy being directed at the magnet, the size of the magnet, and the shape of the magnet. In addition, the polarity of the dispersion loops reverses at predictable intervals.

The dispersion loops are naturally drawn toward the magnetic source, the magnet 12 in a continuous loop, such as illustrated by loops 52 in FIG. 2. However, in the drive system 10, the particle acceleration tubes 14 and 16 are utilized to intercept the dispersion loops and extend the loops to a point in front of the vehicle 30. In the preferred embodiment of the present invention, the dispersion loop needs to be sufficiently far away from the magnet that the dispersion loops provide a pulling force while re-seeking the magnet. Since this distance varies with several factors (e.g., size of magnet, power of magnet, amount of energy striking the magnet, etc.), the correct distance that the dispersion loop must be positioned upon the exit of the acceleration tubes is not constant. The particle acceleration tubes are similar to existing particle beam accelerators. However, the particle acceleration tubes are shaped, sized, and positioned in such a manner as to coincide with a dispersion loop and extend the dispersion loop outwardly. The particle acceleration tube is shaped to include an angular displacement θ from a longitudinal axis Y of approximately between 30 and 40 degrees (preferably approximately 35 degrees). The dispersion loops exit, the particle acceleration tube and re-seek the magnet. In the process of seeking the magnetic source, an attractive force is created. The attractive force of the dispersion loop then pulls the magnet and the attached vehicle forward. In addition, the vehicle is accelerated

At a predicted time interval, the dispersion loop reverses direction (polarity). Therefore, in the preferred embodiment of the present invention, the drive system 10 includes at least two symmetrical particle acceleration tubes. When the polarity of the dispersion loops reverses, the opposite particle acceleration tube captures the symmetrical dispersion loop.

The power source 20 preferably is a power source providing a long-term electrical source, such as from energy generated from radioactive isotope decay. The use of radioactive isotope decay is well known and presently used on power units within existing spacecraft. The ignition system may be any device which provides a directed energy beam, preferably a plasma stream, such as from an arc welder, but with a definitively controllable plasma stream.

With reference to FIGS. 1-3, the operation of the drive system 10 will now be explained. The drive system 10 is installed within the vehicle 30. The vehicle 30 is preferably a spacecraft. The drive system 10 works optimally in a vacuum in a micro-gravity environment. The power source 20 provides electrical power to the ignition system 18. The ignition system generates a directed energy beam or plasma stream 60 toward the magnet 12. Upon impact of the plasma stream on the magnet, the energy is dispersed along dispersion loops 40 and 50 outwardly from the magnet. Without the guidance of the particle acceleration tubes 14 and 16, the dispersion loops would immediately return to the magnet, forming a continuous loop. However, with the placement of the particle acceleration tube in front of the magnet, the dispersion loops are directed outwardly, in front of the magnet and vehicle. As the dispersion loops exit the particle acceleration tubes, the dispersion loops are drawn back toward the magnet. However, with the draw of the dispersion loops toward the magnet, the dispersion loops also create an attractive or pulling force which pulls the magnet and vehicle forward. Such a forward pulling force causes the vehicle to be propelled forward, accelerating as the pulling force is continued.

At a predicted time interval, the dispersion loops reverse polarity. Therefore, the oppositely aligned particle acceleration tube captures the now primary dispersion loop to capture the appropriately polarity-oriented dispersion loop. Thus, the pulling force is captured at regular intervals from each particle acceleration tube. In the preferred embodiment of the present invention, two particle acceleration tubes are utilized. However, in alternate embodiments of the present invention, any number of particle acceleration tubes may be utilized to capture a plurality of dispersion loops emanating from the magnet.

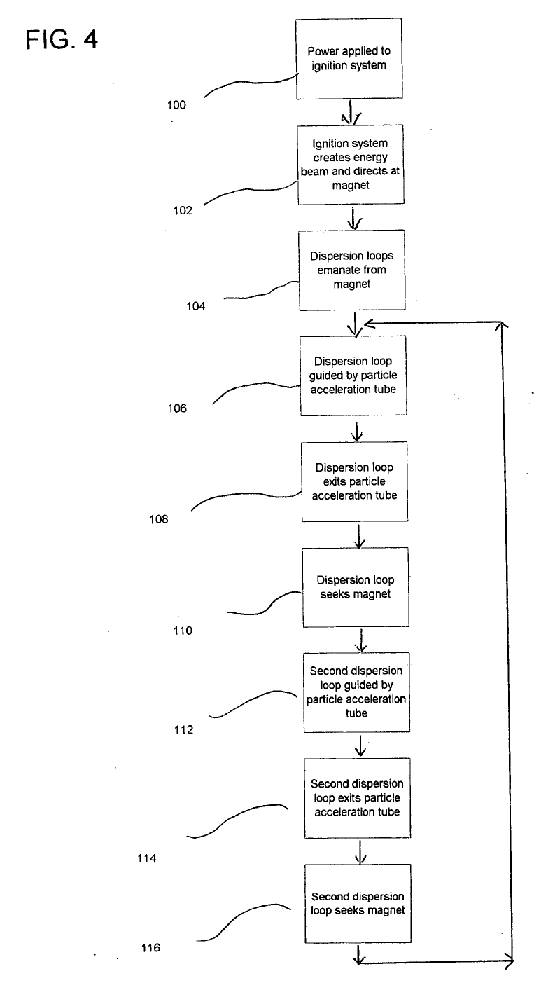

FIG. 4 is a flow chart outlining the steps for propelling a vehicle according to the teachings of the present invention. With reference to FIGS. 1-4, the steps of utilizing the drive system 10 will now be explained. The method begins with step 100 where power is applied from the power source 20 to the ignition system 18. Next, in step 102, the powered ignition system creates an energy beam (plasma stream) which is directed at the magnet 12. In step 104, upon the plasma beam striking the magnet, dispersion loops 40 and 50 emanate from the magnet. It should be understood that more than two dispersion loops may be created, depending on the size and shape of the magnet. In step 106, at least one of the dispersion loops is captured and guided by one of the particle acceleration tubes 14 or 16 outwardly and in front of the magnet and the encompassing vehicle 30.

Next, in step 108, the dispersion loop (e.g., dispersion loop 40) exits the particle acceleration tube (e.g. particle acceleration tube 14). Upon exiting the particle acceleration tube, the dispersion loop attempts to seek the magnet 12 in step 1 10. An attractive pulling force is created from the dispersion loop to the magnet, thereby pulling the magnet and vehicle forwardly. At a predictable time interval, the polarity of the dispersion loop 40 is reversed. Therefore, in step 112, a dispersion loop 50 is guided through the particle acceleration tube 16. In step 114, the dispersion loop 50 exits the particle acceleration tube 16. Upon exiting the particle acceleration tube 16, the dispersion loop 50 attempts to seek the magnet 12 in step 116. An attractive pulling force is created from the dispersion loop to the magnet, thereby pulling the magnet and vehicle forward. At the predictable time interval, the polarity again shifts on the dispersion loops and the method returns to step 106.

Although two particle acceleration tubes are illustrated, it should be understood that any number of particle acceleration tubes may be utilized. In addition, any device may be used which is capable of guiding the dispersion loops in front of the magnet.

The drive system 10 provides many advantages over existing drive systems. No direct consumption of fuel for propelling a spacecraft is required. Another novel feature of this invention is that the acceleration of the vehicle is not velocity restricted, thereby allowing the vehicle to accelerate to high speeds in a short period of time.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

1. A drive system for propelling a vehicle, said drive system comprising:
a magnet mounted within said vehicle;
an ignition system powered by a power source, said ignition system providing a directed energy beam for striking said magnet;
the directed energy source strikes said magnet, upon impact of the directed energy source, a plurality of dispersion loops emanate from said magnet; and
at least one particle acceleration tube for capturing and guiding one of the dispersion loops;
whereby the guided dispersion loop exits said particle acceleration tube and attempts to seek said magnet, thereby creating an attractive pulling force propelling said magnet and said vehicle forward.

2. The drive system for propelling a vehicle of claim 1 wherein said magnet is a natural magnet.

3. The drive system for propelling a vehicle of claim 1 wherein the energy beam is a plasma stream.

4. The drive system for propelling a vehicle of claim 1 wherein said ignition system is a plasma generator creating a directed plasma stream at said magnet.

5. The drive system for propelling a vehicle of claim 1 further comprising a second particle acceleration tube, said second particle acceleration tube for capturing and guiding a second dispersion loop emanating from said magnet, whereby the plurality of dispersion loops reverse polarity at a time interval.

6. The drive system for propelling a vehicle of claim 1 wherein said power source is powered from a radioactive isotope decay energy system.

7. The drive system for propelling a vehicle of claim 1 wherein said particle acceleration tube is inwardly angled from a forward position at an angle between thirty and forty degrees.

8. The drive system for propelling a vehicle of claim 7 wherein said particle acceleration tube is inwardly angled at approximately 35 degrees from a forward position.

9. The drive system for propelling a vehicle of claim 1 wherein the drive system is used for propelling a spacecraft.

10. The drive system for propelling a vehicle of claim 9 wherein a vacuum exists between said magnet and said particle acceleration tube.

11. A drive system for propelling a vehicle, said drive system comprising:
a magnet mounted within said vehicle;
means for creating and directing a plasma stream at said magnet;
the plasma stream strikes said magnet causing a plurality of dispersion loops to emanate from said magnet; and
means for guiding at least one emanating dispersion loop outwardly and in front of the magnet;
whereby the dispersion loop is directed beyond said magnet in such a manner that an attractive pulling force is generated by the dispersion loop to said magnet, thereby propelling said magnet and said vehicle forward.

12. A method of propelling a vehicle, said method comprising the steps of:
applying power to an ignition system;
creating a directed energy beam by the powered ignition system;
directing, by the ignition system, the energy beam toward a magnet;
striking, by the energy beam the magnet;
emanating a plurality of dispersion loops from the magnet;
guiding, by a particle acceleration tube, a dispersion loop outwardly and forward of the magnet;
exiting, by the dispersion loop, from the particle acceleration tube;
seeking, by the dispersion loop, the magnet; and
creating an attractive pulling force by the dispersion loop on the magnet.

13. The method of propelling a vehicle of claim 12 further comprising the steps of:
upon one of the dispersion loops reversing polarity, guiding, by a second particle acceleration tube, a second dispersion loop outwardly and forward of the magnet;
exiting, by the second dispersion loop, from the particle acceleration tube;
seeking, by the second dispersion loop, the magnet; and
creating an attractive pulling force by the second dispersion loop on the magnet.

14. The method of propelling a vehicle of claim 12 wherein the energy beam is a plasma stream.

15. A drive system for propelling a vehicle, said drive system comprising:
a natural magnet mounted within said vehicle;
an ignition system powered by a power, source, said ignition system providing a plasma stream for striking said magnet;
the plasma stream strikes said magnet, upon impact of the plasma stream on said magnet, a plurality of dispersion loops emanate from said magnet; and
at least one particle acceleration tube for capturing and guiding one of the dispersion loops forward of the magnet;
whereby the guided dispersion loop exits said particle acceleration tube and attempts to seek said magnet, thereby creating an attractive pulling force propelling the magnet and vehicle forward.

16. The drive system for propelling a vehicle of claim 15 further comprising a second particle acceleration tube, said second particle acceleration tube for capturing and guiding a second dispersion loop emanating from said magnet, whereby said plurality of dispersion loops reverse polarity at a time interval.

17. The drive system for propelling a vehicle of claim 15 wherein said particle acceleration tube is inwardly angled from a forward position at an angle between thirty and forty degrees.

18. The drive system for propelling a vehicle of claim 17 wherein said particle acceleration tube is inwardly angle at approximately 35 degrees from a forward position.

19. The drive system for propelling a vehicle of claim 15 wherein the drive system propels a spacecraft.

20. The drive system for propelling a vehicle of claim 15 wherein the acceleration tube elongates the guided dispersion loop, upon exiting the acceleration tube the guided dispersion loop contracting back to the magnet to create the attractive pulling force.
